(19) United States
(12) Patent Application Publication
(10) Pub. No.: US 2020/0118138 A1
(43) Pub. Date: Apr. 16, 2020

(54) Device and Method for Identifying a Coached Fraudulent Transaction

(71) Applicant: BehavioSec Inc, San Francisco, CA (US)

(72) Inventors: Julian Breitling, Lulea (SE); Ingo Deutschmann, Merseburg (DE); Per Burstrom, Lulea (SE)

(73) Assignee: BehavioSec Inc

(21) Appl. No.: 16/710,002

(22) Filed: Dec. 11, 2019

(51) Int. Cl. G06Q 20/40; G06N 20/00

(52) U.S. Cl. CPC G06Q 20/4016; G06N 20/00

(57) ABSTRACT

A device identifying a coached fraudulent transaction carried out by a specific user using a computing device. A storage medium of the device has stored a training phase module, including instructions to receive a plurality of training sets of behavioral data and corresponding classifications indicating whether that training set was generated when the user was coached during the online transaction. The training phase module further includes instructions to generate a multi-dimensional classification model for classification of a set of behavioral data. The storage medium has stored an operational phase module, which includes instructions to receive, from the computing device via the network interface, a specific set of behavioral data relating to the behavior of the specific user during a specific online transaction, and instructions to determine, using the multi-dimensional classification model, a likelihood that the specific user was coached during the specific online transaction.

### FIELD AND BACKGROUND OF THE DISCLOSED TECHNOLOGY

The disclosed technology relates generally to authentication devices and methods, and, more specifically, to a device and a method for identifying or detecting a coached fraudulent transaction, in which a fraudster coaches a user, for example over the phone, to carry out a specific fraudulent transaction. Such coached fraudulent transactions are also known as vishing attacks.

Electronic devices are used by millions of people to perform many types of operations, such as communicating with other people (e.g. by email, instant messaging, phone calls, and video chats), capturing memories (e.g. taking pictures, videos, and voice recordings), entertainment (e.g. listening to music, watching videos, playing games), financial transactions (e.g. access to bank accounts, transferring funds, shopping) and the like.

Some of the more sensitive transactions that may be carried out using electronic devices, such as transactions requiring transfer of funds (e.g. shopping, bank account transactions, and the like), require authentication of the user in order to ensure that the user carrying out the transaction is indeed the human authorized to do so.

In an attempt to get around the authentication requirements, criminals and fraudsters have developed different types of attacks in which the authorized user is authenticated, but the transaction is a fraudulent transaction, not the transaction the authorized user thinks he/she is conducting.

One such type of attack, is a “phishing” attack, in which the fraudster creates a fraudulent log-in interface or sends a fraudulent request, posing as an actual website or an authorized service provider. The unsuspecting user then provides their authentication information or their restricted information (such as bank account or credit card information) enabling the attacker to steal the user credential and use them freely for purposes of fraud and theft. There are many mechanism known in the art for detection of such phishing attacks.

Another type of attack is known as a “vishing” attack, in which a fraudster poses as an authorized service provider, and guides an unsuspecting authorized user through the various steps of performing an electronic financial transaction. For example, the fraudster may telephone the victim and provide oral instructions for performing the transaction. However, the transaction is a fraudulent transaction. For example, the attacker may guide the user to access an authentic website, such as their actual bank account, and to wire money to a specific bank account number of the victim, while pretending that this is required in order to move the bank account of the victim to a safer account, or to open a pension fund or an insurance fund for the victim.

Vishing attacks are difficult to detect, because the user conducting the electronic transaction is the authorized user using his/her standard electronic device and IP address, and providing his/her actual authentication credentials of the authorized user. In fact, any security measures aimed to authenticate the identity of the user, such as two-factor authentication or use of biometric data, would be ineffective for identifying a vishing attack, because the authorized user is the one carrying out the transaction.

It has been discovered that vishing attacks may be detected by detecting behavioral traits of the user. For example, a user being coached through an operation, may be waiting to receive the next instruction from the coaching fraudster, which wait time does not exist when the user performs the same transaction of their own volition, without being coached.

U.S. Patent Application Publication No. 2019/0158535 to Kedem et al describes a system for detecting a vishing attack, and relates to various detectors for behavior, such as a data entry rhythm detector, a spatial characteristics detector, a doodling detector, and a typographical errors rhythm detector.

There is thus a need in the art for a system and method for detecting coached fraudulent transactions, which system is a learning system automatically learning the thresholds and weights assigned to each of various input parameters in order to identify coached fraudulent transactions at a high confidence.

### SUMMARY OF THE DISCLOSED TECHNOLOGY

The disclosed technology relates generally to authentication devices and methods, and, more specifically, to a device and a method for identifying or detecting a coached fraudulent transaction, in which a fraudster coaches a user, for example over the phone, to carry out a specific fraudulent transaction. Such coached fraudulent transactions are also known as vishing attacks.

In the context of the present specification and claims, the term “dataset” or “set of data” is defined as a data sample including all the data collected during a single recorded user session, or during a single specific online transaction.

In the context of the present specification and claims, the term “approximately” is defined as being within 10% of a target number or measure.

It should be understood that the use of “and/or” is defined inclusively such that the term “a and/or b” should be read to include the sets: “a and b,” “a or b,” “a,” “b.”

According to an aspect of some embodiments of the teachings herein, there is provided a device, or server, identifying a coached fraudulent transaction carried out by a specific user using a computing device associated with at least one input interface. The device includes a network interface with a packet-switched network connection to the computing device, a processor in communication with the network interface, and a non-transitory computer readable storage medium for instructions execution by the processor.

The non-transitory computer readable storage medium has stored a training phase module, which includes instructions to receive a plurality of training sets of behavioral data relating to the behavior of one or more users during an online transaction, and instructions to receive, for each training set of the plurality of training sets of behavioral data, a classification indicating whether that training set was actually generated when the user was coached during the online transaction. The training phase module further includes instructions to generate, based on the plurality of training sets of behavioral data and the corresponding classifications, a multi-dimensional classification model for classification of a set of behavioral data.

The non-transitory computer readable storage medium has stored an operational phase module, which includes instructions to receive, from the computing device via the network interface, a specific set of behavioral data relating to the behavior of the specific user during a specific online transaction, and instructions to determine, using the multi-dimensional classification model, a likelihood that the specific user was coached during the specific online transaction.

Each of the plurality of training sets and the specific set of behavioral data includes at least two behavioral parameters selected from the group consisting of:

a total timespan from selecting a text field for input thereinto, to leaving the text field, for at least one of a text field relating to a recipient account identifier, a text field relating to a recipient name, and a text field relating to an amount;

a number of times during a corresponding online transaction that a corresponding user stops moving a cursor;

a number of times during a corresponding online transaction that at least one of a plurality of cursor criteria is outside of a corresponding predetermined range;

a timespan between selecting the text field relating to a recipient name and beginning to enter input into the text field relating to a recipient name;

a total time spent on a monetary transfer page during the corresponding online transaction;

a total time during which a cursor was immobile while interacting with the monetary transfer page during the corresponding online transaction;

a timespan between selecting the text field relating to a recipient account identifier and beginning to enter input into the text field relating to a recipient account identifier; and a number of cursor engagements in the monetary transfer page during the corresponding online transaction.

In some embodiments, the at least one input interface includes a mouse. In some such embodiments, the cursor engagements may include mouse clicks.

In some embodiments, the cursor criteria of the behavioral parameters include, for a specific mouse gesture:

a ratio between the shortest distance between two endpoints of the specific mouse gesture and the length of the specific mouse gesture;

a linearity measure indicating how similar the specific mouse gesture is to a straight line;

a ratio between the length of the specific mouse gesture and the length of a perimeter of a rectangle enclosing the specific mouse gesture;

a maximal change in the x-direction during the mouse gesture; and

a maximal change in the y-direction during the mouse gesture.

In some embodiments, the specific online transaction is a banking transaction.

In some embodiments, the specific set of behavioral data includes data relating to the entirety of the specific online transaction, received in a single bulk transfer.

In some embodiments, the instructions in the operational phase module are carried out in real time, during the specific online transaction. In some such embodiments, the specific set of behavioral data is received in multiple portions, as the data is being collected in real time.

In some embodiments, the operational phase module further includes instructions to carry out a coached transaction routine, which instructions are to be carried out in response to the determined likelihood being above a predetermined threshold.

In some embodiments, the device is functionally associated with at least one output interface, and the coached transaction routine includes providing to an operator of the device, via the at least one output interface, an indication that the specific transaction was a coached transaction.

In some embodiments, the one or more users, whose data sets are used in the training phase, include at least one user which is different from the specific user. In some such embodiments, all of the one or more users are different from the specific user.

According to an aspect of some embodiments of the teachings herein, there is provided a system for identifying that a specific online transaction carried out by a specific user is a coached fraudulent transaction. The system includes a device identifying a coached fraudulent transaction as described hereinabove. The system further includes a computing device used by the specific user for conducting the specific online transaction.

The computing device includes at least one input interface used by the specific user to provide input during the specific online transaction, a computing device network interface with a packet switched network connection to the network interface of the device identifying a coached fraudulent transaction, a computing device processor in communication with the at least one input interface and with the computing device network interface, and a computing device non-transitory computer readable storage medium for instructions execution by the computing device processor.

The computing device non-transitory computer readable storage medium has stored instructions to collect behavioral data relating to behavior of the specific user during the specific online transaction, and instructions to transmit at least part of the collected behavioral data to the processor of the device identifying a coached fraudulent transaction.

In some embodiments, the instructions to transmit the collected behavioral data include instructions to transmit each element of the collected behavioral data as it is collected, in real time. In some other embodiments, the instructions to transmit the collected behavioral data include instructions to transmit behavioral data collected during the entirety of the specific online transaction at once, following collection of all such data.

According to an aspect of some embodiments of the teachings herein, there is provided a method for identifying a coached fraudulent transaction, carried out by a specific user using a computing device associated with at least one input interface. The method includes a training phase and an operational phase.

The training phase includes receiving a plurality of training sets of behavioral data relating to the behavior of a user during an online transaction, and receiving, for each training set of the plurality of training sets of behavioral data, a classification indicating whether the specific training set was actually generated when the user was coached during the online transaction. The training phase further includes generating, based on the plurality of training sets of behavioral data and the corresponding classifications, a multi-dimensional classification model for classification of a set of behavioral data.

The operational phase includes receiving, from the computing device, a specific set of behavioral data relating to the behavior of the specific user during a specific online transaction, and determining, using the multi-dimensional classification model, a likelihood of the specific user was coached during the specific online transaction.

Each of the plurality of training sets and the specific set of behavioral data includes at least two behavioral parameters selected from the group consisting of:

a total timespan from selecting a text field for input thereinto, to leaving the text field, for at least one of a text field relating to a recipient account identifier, a text field relating to a recipient name, and a text field relating to an amount;

a number of times during a corresponding online transaction that a corresponding user stops moving a cursor;

a number of times during a corresponding online transaction that at least one of a plurality of cursor criteria is outside of a corresponding predetermined range;

a timespan between selecting the text field relating to a recipient name and beginning to enter input into the text field relating to a recipient name;

a total time spent on a monetary transfer page during the corresponding online transaction;

a total time during which a cursor was immobile while interacting with the monetary transfer page during the corresponding online transaction;

a timespan between selecting the text field relating to a recipient account identifier and beginning to enter input into the text field relating to a recipient account identifier; and a number of cursor engagements in the monetary transfer page during the corresponding online transaction.

In some embodiments, the at least one input interface includes a mouse. In some such embodiments, the cursor engagements include mouse clicks. Additionally or alternatively, the cursor criteria include, for a specific mouse gesture, one or more of:

a ratio between the shortest distance between two endpoints of the specific mouse gesture and the length of the specific mouse gesture;

a linearity measure indicating how similar the specific mouse gesture is to a straight line;

a ratio between the length of the specific mouse gesture and the length of a perimeter of a rectangle enclosing the specific mouse gesture;

a maximal change in the x-direction during the mouse gesture; and

a maximal change in the y-direction during the mouse gesture.

In some embodiments, the specific online transaction is a banking transaction.

In some embodiments, the specific set of behavioral data includes data relating to the entirety of the specific online transaction.

In some such embodiments, the specific set of behavioral data is received at once, in bulk, in a single transmission.

In some other such embodiments, the operational phase is carried out in real time, during the specific online transaction. In some such embodiments, the specific set of behavioral data is received in parts, as multiple behavioral parameters, where each behavioral parameter is received in real time as the behavioral parameter is collected by the computing device.

In some embodiments, the operational phase further includes, in response to the determined likelihood being above a predetermined threshold, carrying out a coached transaction routine.

In some embodiments, the method further includes, at the computing device, collecting at least part of the specific set of behavioral data.

According to an aspect of some embodiments of the teachings herein, there is provided a program code product executing the method described herein on at least one computational device.

Any device or step to a method described in this disclosure can comprise or consist of that which it is a part of, or the parts which make up the device or step. The term “and/or” is inclusive of the items which it joins linguistically and each item by itself. “Substantially” is defined as “at least 95% of the term being described” and any device or aspect of a device or method described herein can be read as “comprising” or “consisting” thereof.

### BRIEF DESCRIPTION OF THE DRAWINGS

FIG. 1A is a block diagram of a system for identifying a coached fraudulent transaction according to an embodiment of the teachings herein.

FIG. 1B is a block diagram of a device, or server, identifying a coached fraudulent transaction forming part of the system of FIG. 1A.

FIG. 1C is a block diagram of a user-operated computing device forming part of the system of FIG. 1A.

FIG. 2 is a flow chart of a method for identifying a coached fraudulent transaction according to an embodiment of the teachings herein.

A better understanding of the disclosed technology will be obtained from the following detailed description of the preferred embodiments taken in conjunction with the drawings and the attached claims.

### DETAILED DESCRIPTION OF EMBODIMENTS OF THE DISCLOSED TECHNOLOGY

In an embodiment of the disclosed technology, a learning system is trained so as to form a multi-dimensional classification model for identifying coached fraudulent transactions, based on behavioral information relating to a user carrying out the transaction. The system is then used to determine the likelihood that received behavioral data, collected during an online transaction of a user, was collected during a coached fraudulent transaction. The determination may be carried out in real-time, or in retrospect after the transaction has been completed.

Embodiments of the disclosed technology will become clearer in view of the following description of the drawings.

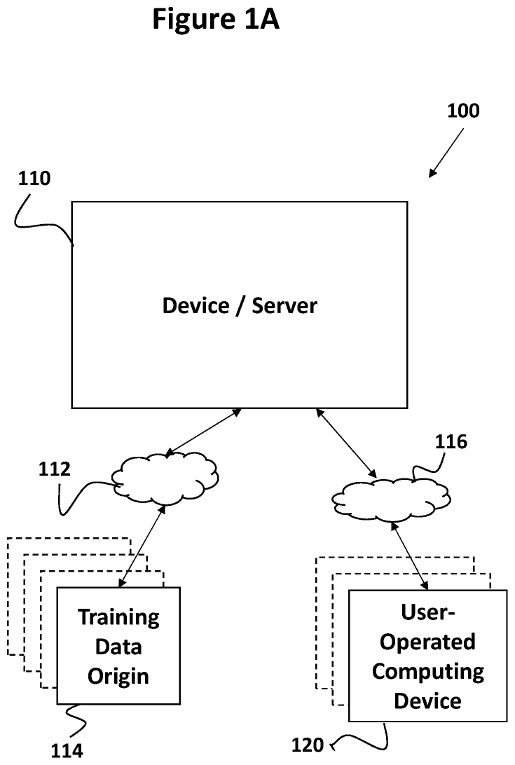

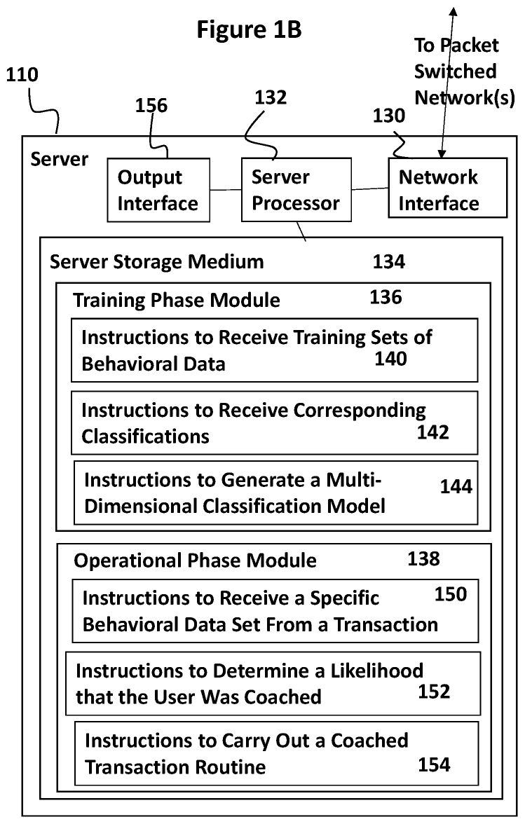

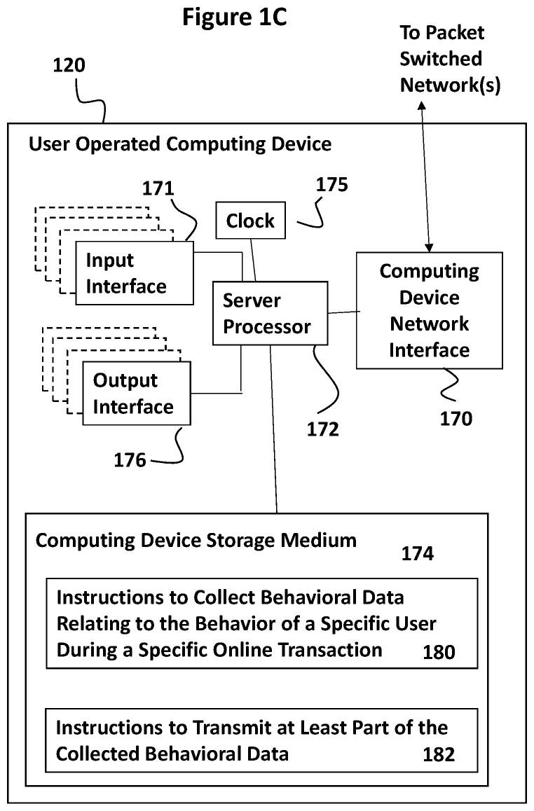

Reference is now made to FIG. 1A, which is a block diagram of a system 100 for identifying a coached fraudulent transaction according to an embodiment of the teachings herein. The system 100 includes a device 110, also termed a server 110 herein, for identifying a coached fraudulent transaction. Server 110 is connected, via one or more packet switched networks 112, to at least one training data origin 114, adapted to provide to server 110 a plurality of sets of behavioral data for a training phase thereof. Server 110 is further connected, via a packet switched network 116, to at least one user operated computing device 120, adapted to be used by a specific user to carry out a specific online transaction.

In some embodiments, packet switched networks 112 and 116 may be a single packet switched network.

Referring additionally to FIG. 1B, which is a block diagram of server 110, it is seen that server 110 includes at least one network interface 130 for communication to packet switched networks 112 and/or 116, a server processor 132 in communication with the network interface, and a server non-transitory computer readable storage medium 134. The storage medium 134 stores instructions for execution by server processor 132. The instructions stored in storage medium 134 are divided into training phase module instructions 136, to be executed by processor 132 during a training phase of the server 110, and operational phase module instructions 138, to be executed by processor 132 following completion of execution of the training phase module instructions, during an operational phase of the server 110.

Specifically, the training phase module instructions 136 include:
instructions 140, to receive a plurality of training sets of behavioral data relating to the behavior of one or more users during an online transaction;
instructions 142, to receive, for each training set of the plurality of training sets of behavioral data, a classification indicating whether that training set was actually generated when the user was coached during the online transaction, i.e., labels for the training data sets; and
instructions 144, to generate, based on the plurality of training sets of behavioral data and their corresponding classifications, a multi-dimensional classification model for classification of a set of behavioral data.

During execution of the instructions 140 and 142, the plurality of training sets of behavioral data and the corresponding classifications may be received from the one or more training data origins 114. In some embodiments, the training sets of behavioral data may be collected on a single computing device forming a training data origin, and received by the server 110 as one or more transmissions from the single training data origin 114. In other embodiments, the training sets of behavioral data may be provided from multiple computing devices on which these training sets of data were collected, and may be received by the server 110 as multiple transmissions from multiple training data origins.

In some embodiments, the plurality of training sets of behavioral data relate to the behavior of a single user, during multiple online transactions. In some embodiments, the plurality of training sets of behavioral data relate to the behavior of multiple users, and are collected during one or more online transactions conducted by each of the multiple users.

In some embodiments, at least one of the plurality of training sets of behavioral data relates to the specific user operating computing device 120. In some such embodiments, computing device 120 may be one of training data origins 114, or may be in communication with one of training data origins 114 for transmission of one or more collected training sets of behavioral data and corresponding classifications thereto. In some such embodiments, computing device 120 forms part of packet switched network 112, or is in communication with one of training data origins 114 via another packet switched network, not explicitly shown.

Specifically, the operational phase module instructions 138 include:
instructions 150, to receive, from computing device 120 via network 116, specific sets of behavioral data relating to the behavior of the specific user of computing device 120 during a specific online transaction; and
instructions 152, to determine, using the multi-dimensional classification model, a likelihood that the specific user was coached during the specific online transaction.

In some embodiments, the operational phase module instructions 138 further include instructions 154, to carry out a coached transaction routine, to be carried out in response to said determined likelihood being above a predetermined threshold. For example, a coached transaction routine may include nullifying of the transaction, providing a notification to an operator of the server 110, or to computing device 120 that the transaction is fraudulent, or contacting enforcement authorities, such as a cyber crime department of the police, to report the coached fraudulent transaction. In some such embodiments, server 110 may further be associated with an output interface 156, such as a screen or audio speaker, for providing output to an operator, or may include a communication interface for contacting enforcement authorities.

Referring now to FIG. 1C, which is a block diagram of computing device 120, it is seen that computing device 120 includes at least one computing device network interface 170 for communication to packet switched network 116, at least one input interface 171, adapted to be used by the specific user to provide input during the specific online transaction. For example, input interface 171 may include a mouse, keyboard, touchpad, touchscreen, microphone, or the like. Computing device 120 further includes a computing device processor 172 in communication with the network interface 170 and with the input interface(s) 171, and a computing device non-transitory computer readable storage medium 174. The storage medium 174 stores instructions for execution by computing device processor 172. In some embodiments, computing device 120 further includes a clock, or other timing mechanism, 175, functionally associated with at least one of input interface(s) 171 and computing device processor 172. Clock 175 may be adapted, for example, to provide a time stamp at which input interface(s) 171 is used, or to measure the duration of a specific operation of use of the input interface(s), as explained further hereinbelow.

The storage medium 174 has stored thereon:
instructions 180, to collect behavioral data relating to behavior of the specific user during the specific online transaction, for example via input interface(s) 171; and
instructions 182, to transmit at least part of the collected behavioral data to the server 110 (as the specific set of behavioral data).

In some embodiments, particularly ones in which server 110 includes instructions 154 to carry out a coached fraud routine, computing device 120 may further include, or be associated with, one or more output interfaces 186, such as a screen or audio speaker, for providing an indication of fraud received from server 110 to the specific user.

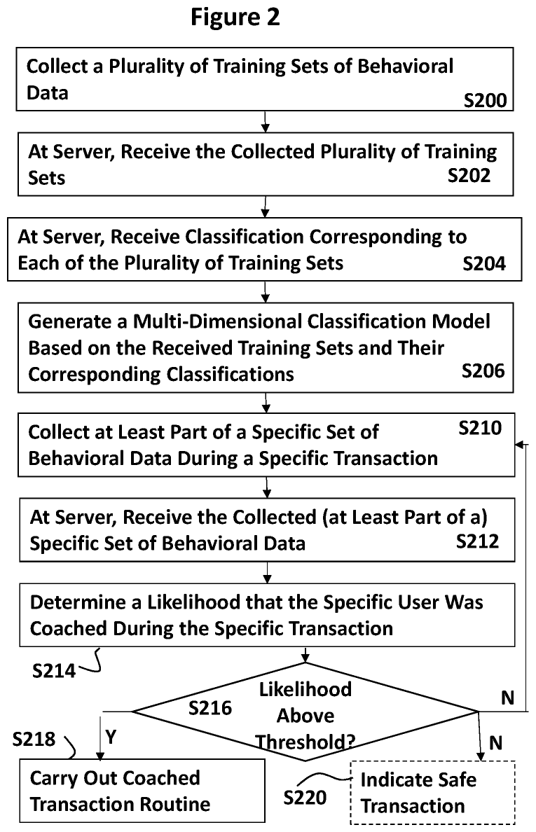

The sets of behavioral data received by execution of instructions 140 by server processor 132, as well as the set of behavioral data of the specific user received by execution of instructions 150 by server processor 132, which behavioral data of the specific user was collected and transmitted by execution of instructions 180 and 182 by computing device processor 172, typically include multiple behavioral parameters. The data is typically collected with respect to completion of an online form, which may include text fields, require cursor movement between fields, and involve operations carried out by input interface(s) 171 such as a mouse and/or a keyboard. Specific behavioral parameters included in the data sets are described hereinbelow with respect to FIG. 2.

In some embodiments, the behavioral parameters collected by execution of instructions 180, are transmitted to server 110 by execution of instructions 182 in real-time, as each behavioral parameter is collected. In such embodiments, execution of instructions 150 of the server receiving the specific data set relating to the specific user may be staggered, such that the receiving step 150 occurs as each behavioral parameter is transmitted from the user computing device 120.

In some such embodiments, each time one or more behavioral parameters are received by server 110, instructions 152 are executed to determine a likelihood of a coached transaction based on the currently available behavioral parameters, and the assessment of likelihood is reevaluated each time additional behavioral parameters are received. In some other such embodiments, although the behavioral parameters are received by server 110 as they become available and are transmitted from computing device 120, the determination of likelihood of a coached transaction, by execution of instructions 152, occurs only one time, typically following receipt of all behavioral data for the transaction.

In other embodiments, the behavioral parameters collected by execution of instructions 180, are transmitted to server 110 once, following collection of the whole data set, including all the behavioral parameters of the entire transaction, by execution of instructions 182. The assessment of the data set by execution of instructions 152 occurs only once. The transmission of the entire data set may occur immediately when the last behavioral parameter is collected, or may occur at some later stage.

Reference is now made to FIG. 2, which is a flow chart of a method for identifying a coached fraudulent transaction according to an embodiment of the teachings herein. FIG. 2 is described herein with respect to the system 100 of FIG. 1A and its components described in FIGS. 1B and 1C. However, the scope of the teachings is not limited to implementation of the disclosed method using this system.

At an initial, preparatory step S200, a plurality of training sets of behavioral data relating to the behavior of one or more users during one or more corresponding online transactions are collected. The training sets are typically collected by one or more computing devices on which the one or more transactions are carried out, and in some embodiments may then be transferred to a single training data origin 114 (FIG. 1A). Each training set of behavioral data is associated with a classification indicating whether that training set was generated when the user was coached during the corresponding online transaction.

At step S202, which forms part of a training phase of the method, a plurality of training sets of behavioral data are received, for example by server 110 executing instructions 140. In such embodiments, the training sets are received from training data origin(s) 114, and are the training sets that were collected at step S200. The classifications corresponding to each of the training sets of behavioral data are received at step S204, for example by server 110 executing instructions 142, which also forms part of the training phase.

At step S206, which is still part of the training phase, a multi-dimensional classification model is generated based on the plurality of training sets of behavioral data received at step S202, and their corresponding classifications received at step S204. The multi-dimensional classification model is useful for classification of a set of behavioral data, as explained in further detail hereinbelow.

In some embodiments, the plurality of training sets of behavioral data relate to the behavior of a single user, during multiple online transactions. In some embodiments, the plurality of training sets of behavioral data relate to the behavior of multiple users, and are collected during one or more online transactions conducted by each of the multiple users.

In some embodiments, at least one of the plurality of training sets of behavioral data relates to the specific user operating computing device 120. In some such embodiments, computing device 120 may be one of training data origins 114, or may be in communication with one of training data origins 114 for transmission of one or more collected training sets of behavioral data and corresponding classifications thereto. In some such embodiments, computing device 120 forms part of packet switched network 112, or is in communication with one of training data origins 114 via another packet switched network, not explicitly shown.

Subsequently, at a step S210 of an operational phase of the method, at least part of a specific set of behavioral data relating to the behavior of a specific user during a specific online transaction is collected, for example by computing device 120 executing instructions 180 thereof using input interface(s) 171. For example, the specific transaction may be a banking transaction, a shopping transaction, or an insurance related transaction. The collected behavioral data is transmitted from computing device 120 and is received by server 110 at step S212, for example by execution of instructions 182 by computing device 120 and of instructions 150 of server 110.

At step S214, server 110 determines, for example by execution of instructions 152, a likelihood that the specific user was coached during the specific online transaction. The determination is made using the multi-dimensional classification model generated at step S206. At step S216, the server 110 determines whether the likelihood of the specific online transaction being a coached online transaction exceeds a predetermined threshold. In some embodiments, if the predetermined threshold is exceeded, a coached transaction routine is carried out at step S218. The coached transaction routine may include various operations, such as, for example, nullifying the transaction, providing a notification to an operator of the server 110 and/or to computing device 120 that the transaction is fraudulent, and/or contacting enforcement authorities, such as a cyber crime department of the police, to report the coached fraudulent transaction.

The sets of behavioral data received at step S202, as well as the specific set of behavioral data received at step S212, typically include multiple behavioral parameters. The data is typically collected with respect to completion of an online form, which may include text fields, require cursor movement between fields, and involve operations carried out by input interface(s) such as a mouse and/or a keyboard.

In some embodiments, the behavioral parameters collected at step S210, are received by server 110 at step S212 in real-time, as each behavioral parameter is collected. In such embodiments, step S212 may be staggered, and may occur as each behavioral parameter is transmitted from the user computing device 120.

In some such embodiments, each time one or more behavioral parameters are received at step S212, the flow moves to step S214 to determine the likelihood of a coached transaction based on the received behavioral parameters. In such embodiments, if at step S216 it is determined that the predetermined threshold hasn't been met, the flow returns to step S210, to await collection and receipt of one or more additional behavioral parameters of the specific set of behavioral data, and thereafter the classification and evaluation of steps S214 and S216 are repeated.

In other embodiments, while the behavioral parameters are received in a staggered manner at step S212, the determination of a likelihood at step S214 and the evaluation of the likelihood at step S216 occur only once, after all the behavioral parameters have been received (for example the system may know what behavioral parameters are expected and wait to receive input for all those parameters, or alternatively the system may set a predefined time threshold such that if additional data is not received within a predetermined duration, the data set is considered to have been completed).

In yet other embodiments, the behavioral parameters collected at step S210 are received by server 110 at once at a single execution of step S212, following collection of the whole data set, including all the behavioral parameters of the entire transaction. In such embodiments, the determination of likelihood at step S214 and the evaluation of the likelihood at step S216 occur only once.

In cases in which steps S214 and S216 occur only once, if at step S216 it is determined that the likelihood of a coached transaction is smaller than the predetermined threshold, the method may terminate, or alternatively the method may include an additional step S220 in which an indication is provided that the transaction was a safe and valid transaction (i.e. safe from a behavioral perspective and representative of a transaction which lacks coaching by a third party seeking to illicitly gain funds). The indication may be provided, for example, to an operator of server 110, for example via an output interface thereof, or to the specific user via an output interface of computing device 120.

Typically, each of the plurality of training sets received at step S202 and the specific set of behavioral data received at step S212 includes at least two behavioral parameters selected from the group consisting of:
a total timespan from selecting a text field for input thereinto, to leaving the text field, for at least one of a text field relating to a recipient account identifier, a text field relating to a recipient name, and a text field relating to an amount;
a number of times during a corresponding online transaction that a corresponding user stops moving a cursor;
a number of times during a corresponding online transaction that at least one of a plurality of cursor criteria is outside of a corresponding predetermined range;
a timespan between selecting the text field relating to a recipient name and beginning to enter input into the text field relating to a recipient name;
a total time spent on a monetary transfer page during the corresponding online transaction;
a total time during which a cursor was immobile while interacting with the monetary transfer page during the corresponding online transaction;
a timespan between selecting the text field relating to a recipient account identifier and beginning to enter input into the text field relating to a recipient account identifier; and
a number of cursor engagements in the monetary transfer page during the corresponding online transaction.

In some embodiments, each data set may include at least three, at least four, or all of the behavioral parameters listed above, and/or multiple instances of any one or more of the behavioral parameters listed above.

In some embodiments, the input interface(s) 171 of computing device 120 include a mouse. In some such embodiments, the cursor engagements comprise mouse clicks. In some such embodiments, the cursor criteria include, for a specific mouse gesture, any one or more of the following criteria:
a ratio between the shortest distance between two endpoints of the specific mouse gesture and the length of the specific mouse gesture;
a linearity measure indicating how similar the specific mouse gesture is to a straight line;
a ratio between the length of the specific mouse gesture and the length of a perimeter of a rectangle enclosing the specific mouse gesture;
a maximal change in the x-direction during the mouse gesture; and
a maximal change in the y-direction during the mouse gesture.

In some embodiments, any one or more of the plurality of training sets received at step S202 and the specific set of behavioral data received at step S212, or each of these sets of behavioral data, may additionally include one or more additional behavioral parameters selected from the group consisting of:
a timespan between selecting the text field relating to an amount of the transaction and beginning to enter input into that text field relating to the amount;
a sum of all timespans of all cursor movements while on the monetary transfer page during the corresponding online transaction;
a measure of the variability of ratios between the length of a specific cursor gesture or motion and the length of a perimeter of a rectangle enclosing the specific cursor gesture;
a count of the total number of cursor gestures;
a measure of the variability of straightness of cursor gestures or motions;
a number of changes of horizontal direction which occur during cursor motions;
an average speed of moving the cursor in all recorded cursor gestures;
a number of keystrokes in a text field relating to the recipient account identifier, including typing errors and corrections thereof;
a total timespan from leaving the text field relating to the amount of the transaction to a time of selecting a next text field for input thereinto;
a number of times the ‘backspace’ or ‘delete’ keys are used while filling in the text field relating to the recipient account identifier;
an average of ratios between the length of a specific cursor gesture or motion and the length of a perimeter of a rectangle enclosing the specific cursor gesture, for all cursor gestures;
an average of the distance travelled with the cursor on the screen during a single cursor gesture;
a measure of the variability of ratios between the shortest distance between two endpoints of the specific cursor gesture and the length of the specific cursor gesture;
a measure of the variability of speeds of cursor gestures;
a length of one or more cursor movements between selecting the text field relating to a recipient identifier of the transaction and beginning to enter input into that text field relating to the recipient identifier;
a sum of the lengths of all cursor gestures;
a number of keystrokes in a text field relating to the amount of the transaction, including typing errors and corrections thereof;
a number of times the ‘backspace’ or ‘delete’ keys are used while filling in the monetary transfer page of the corresponding online transaction;
an average time duration between two consecutive cursor gestures while on the monetary transfer page of the corresponding online transaction;
an average measure of the straightness of all recorded cursor gestures;
a ratio of the sum of time between each pair of consecutive cursor gestures and the total time spent on the monetary transfer page of the corresponding online transaction;
a number of times the text field relating to an amount of the transaction is selected for insertion of data thereinto during navigating on the monetary transfer page of the corresponding online transaction;
a ratio between the number of times during a corresponding online transaction that at least one of a plurality of cursor criteria is outside of a corresponding predetermined range and a theoretical maximum number of times it is possible for all of the plurality of cursor criteria to be outside of the corresponding predetermined range;
a total timespan from leaving the text field relating to the recipient identifier to a time of selecting a next text field for input thereinto;
a total number of keystrokes during the time spent on the monetary transfer page of the corresponding online transaction, including typing errors and corrections thereof;
an average length of cursor gestures between two timestamps, both of the two timestamps occurring before selecting the text field relating to the amount of the transaction and beginning to enter input into that field;
a number of changes of vertical direction which occur during cursor motions;
a number of times the ‘backspace’ or ‘delete’ keys are used while filling in the text field relating to the recipient identifier;
a number of keystrokes during filling in the text field relating to the recipient identifier, including typing errors and corrections thereof;
a number of times the ‘TAB’ key was used while on the monetary transfer page of the corresponding online transaction;
a total timespan from leaving the text field relating to the recipient account identifier to a time of selecting a next text field for input thereinto;
an average timespan of a single cursor gesture;
a length of cursor movements between selecting of the text field relating to the recipient account identifier and beginning typing in that text field;
an average length of cursor gestures between two timestamps, both of the two timestamps occurring before selecting the text field relating to the recipient account identifier and beginning to enter input into that field;
a number of times the text field relating to the recipient account identifier is selected for insertion of data thereinto during navigating on the monetary transfer page of the corresponding online transaction; and
a number of times the ‘backspace’ or ‘delete’ keys are used while filling in the text field relating to the amount of the transaction identifier.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A device identifying a coached fraudulent transaction carried out by a specific user using a computing device associated with at least one input interface, the device comprising:
a. a network interface with a packet-switched network connection to the computing device;
b. a processor in communication with said network interface; and
c. a non-transitory computer readable storage medium for instructions execution by the processor, the non-transitory computer readable storage medium having stored:
A) a training phase module, including:
i. instructions to receive a plurality of training sets of behavioral data relating to the behavior of one or more users during an online transaction;
ii. instructions to receive, for each training set of said plurality of training sets of behavioral data, a classification indicating whether that training set was actually generated when said user was coached during said online transaction; and
iii. instructions to generate, based on said plurality of training sets of behavioral data and said corresponding classifications, a multi-dimensional classification model for classification of a set of behavioral data; and
B) an operational phase module, including:
i. instructions to receive, from the computing device via said network interface, a specific set of behavioral data relating to the behavior of the specific user during a specific online transaction; and
ii. instructions to determine, using said multi-dimensional classification model, a likelihood that said specific user was coached during said specific online transaction,
wherein each of said plurality of training sets and said specific set of behavioral data includes at least two behavioral parameters selected from the group consisting of:
a total timespan from selecting a text field for input thereinto, to leaving the text field, for at least one of a text field relating to a recipient account identifier, a text field relating to a recipient name, and a text field relating to an amount;
a number of times during a corresponding online transaction that a corresponding user stops moving a cursor;
a number of times during a corresponding online transaction that at least one of a plurality of cursor criteria is outside of a corresponding predetermined range;
a timespan between selecting said text field relating to a recipient name and beginning to enter input into said text field relating to a recipient name;
a total time spent on a monetary transfer page during said corresponding online transaction;
a total time during which a cursor was immobile while interacting with said monetary transfer page during said corresponding online transaction;
a timespan between selecting said text field relating to a recipient account identifier and beginning to enter input into said text field relating to a recipient account identifier; and
a number of cursor engagements in said monetary transfer page during said corresponding online transaction.

2. The device of claim 1, wherein the at least one input interface includes a mouse.

3. The device of claim 2, wherein said cursor engagements comprise mouse clicks.

4. The device of claim 2, wherein said cursor criteria include, for a specific mouse gesture, at least one of:
a ratio between the shortest distance between two endpoints of said specific mouse gesture and the length of said specific mouse gesture;
a linearity measure indicating how similar said specific mouse gesture is to a straight line;
a ratio between said length of said specific mouse gesture and the length of a perimeter of a rectangle enclosing said specific mouse gesture;
a maximal change in the x-direction during said mouse gesture; and
a maximal change in the y-direction during said mouse gesture.

5. The device of claim 1, wherein said specific online transaction is a banking transaction.

6. The device of claim 1, wherein said specific set of behavioral data includes data relating to the entirety of said specific online transaction.

7. The device of claim 1, wherein said instructions in said operational phase module are carried out in real time, during said specific online transaction.

8. The device of claim 1, wherein said operational phase module further includes instructions to carry out a coached transaction routine, to be carried out in response to said determined likelihood being above a predetermined threshold.

9. The device of claim 8, functionally associated with at least one output interface, wherein said coached transaction routine includes providing to an operator of said device, via said at least one output interface, an indication that said specific transaction was a coached transaction.

10. The device of claim 1, wherein said one or more users include at least one user which is different from the specific user.

11. A system for identifying that a specific online transaction carried out by a specific user is a coached fraudulent transaction, the system comprising:
a device identifying a coached fraudulent transaction according to claim 1;
a computing device used by the specific user for conducting the specific online transaction, the computing device including:
at least one input interface used by the specific user to provide input during the specific online transaction;
a computing device network interface with a packet switched network connection to said network interface of said device identifying a coached fraudulent transaction;
a computing device processor in communication with said at least one input interface and with said computing device network interface; and
a computing device non-transitory computer readable storage medium for instructions execution by said computing device processor, the computing device non-transitory computer readable storage medium having stored:
instructions to collect behavioral data relating to behavior of one or more users during the specific online transaction; and
instructions to transmit at least part of the collected behavioral data to said processor of said device identifying a coached fraudulent transaction.

12. A method for identifying a coached fraudulent transaction, carried out by a specific user using a computing device associated with at least one input interface, the method comprising:
in a training phase:
receiving a plurality of training sets of behavioral data relating to the behavior of one or more users during an online transaction;
receiving, for each training set of said plurality of training sets of behavioral data, a classification indicating whether said specific training set was actually generated when said user was coached during said online transaction; and
generating, based on said plurality of training sets of behavioral data and said corresponding classifications, a multi-dimensional classification model for classification of a set of behavioral data;
in an operational phase;
receiving, from said computing device, a specific set of behavioral data relating to the behavior of the specific user during a specific online transaction; and
determining, using said multi-dimensional classification model, a likelihood of said specific user was coached during said specific online transaction,
wherein each of said plurality of training sets and said specific set of behavioral data includes at least two behavioral parameters selected from the group consisting of:
a total timespan from selecting a text field for input thereinto, to leaving the text field, for at least one of a text field relating to a recipient account identifier, a text field relating to a recipient name, and a text field relating to an amount;
a number of times during a corresponding online transaction that a corresponding user stops moving a cursor;
a number of times during a corresponding online transaction that at least one of a plurality of cursor criteria is outside of a corresponding predetermined range;
a timespan between selecting said text field relating to a recipient name and beginning to enter input into said text field relating to a recipient name;
a total time spent on a monetary transfer page during said corresponding online transaction;
a total time during which a cursor was immobile while interacting with said monetary transfer page during said corresponding online transaction;
a timespan between selecting said text field relating to a recipient account identifier and beginning to enter input into said text field relating to
a recipient account identifier; and
a number of cursor engagements in said monetary transfer page during said corresponding online transaction.

13. The method of claim 12, wherein the at least one input interface includes a mouse and wherein:
said cursor engagements comprise mouse clicks; and
said cursor criteria include, for a specific mouse gesture, at least one of the following criteria:
a ratio between the shortest distance between two endpoints of said specific mouse gesture and the length of said specific mouse gesture;
a linearity measure indicating how similar said specific mouse gesture is to a straight line;
a ratio between said length of said specific mouse gesture and the length of a perimeter of a rectangle enclosing said specific mouse gesture;
a maximal change in the x-direction during said mouse gesture; and
a maximal change in the y-direction during said mouse gesture.

14. The method of claim 12, wherein said specific online transaction is a banking transaction.

15. The method of claim 12, wherein said specific set of behavioral data includes data relating to the entirety of said specific online transaction.

16. The method of claim 12, wherein said operational phase is carried out in real time, during said specific online transaction.

17. The method of claim 12, wherein said operational phase further includes, in response to said likelihood being above a predetermined threshold, carrying out a coached transaction routine.

18. The method of claim 12, further comprising, at said computing device, collecting at least part of said specific set of behavioral data.

19. A program code product executing the method of claim 12 on a computational device.

20. A carrier for a program code product of claim 18.
